(19) United States
(12) Patent Application Publication
(10) Pub. No.: US 2004/0225560 A1
(43) Pub. Date: Nov. 11, 2004

(54) Method and system for including advertisements in output tasks

(75) Inventors: Harry R. Lewis, Longmont, CO (US); Steven M. Gebert, Boulder, CO (US)

Correspondence Address: IBM Corporation, Personal Systems Group, IP Law Dept.9CCA/002-2, P.O. Box 12195, Research Triangle Park, NC, 27709-2195, US

(73) Assignee: International Business Machines Corporation, Armonk, NY

(21) Appl. No.: 10/430,479

(22) Filed: May 6, 2003

(51) Int. Cl. G06F 17/60

(52) U.S. Cl. 705/14

(57) ABSTRACT

Apparatus and method for including advertisements in output tasks. In one aspect of the invention, merchant data is provided to the output device from a merchant, the merchant data including data describing at least one advertisement of the merchant to be available to be output by the output device. Data updates are provided that are received by the output device, where the data updates modify the advertisements or the parameters by which the advertisements are chosen to be output by the output device. The advertisements and information requested by a user can be output by the output device.

### FIELD OF THE INVENTION

The present invention relates to providing advertisements, and more particularly to providing advertisements to users needing printing or other output services for information.

### BACKGROUND OF THE INVENTION

In many situations it is desirable for users to have printing services for particular information they currently possess or which they need to obtain. In such situations, the user may need hard copies for various reasons, including data filing and storage, reliability, backup, or convenience. For example, having a printed hard copy of electronic data is useful for backup purposes, or may be required in some situations, e.g., sending physical mail. Or, in terms of convenience, having a hard copy of the information on paper or other permanent media may be easier than trying to remember the information or viewing the information in other form, such as electronic form. For example, a person may need quick access to the information at a later time, and may not have a electronic device which can record or present the information, or an electronic device may have too small a display to view the information conveniently or may be too cumbersome to access the information quickly, in which cases a printed copy of the information would be desirable.

Having printouts or copies of data is essential and required in many types of businesses and other applications. The types of situations in which convenience printing can be desirable are also numerous. For example, a person may be in a public place, such as in an airport or city downtown, and need information about local and nearby services, such as restaurants, hotels, gas stations, businesses, etc. In some places, these information needs can be met by using an automated information terminal or kiosk, or an information booth or information desk located in the lobby of a hotel or other building. If computer devices are used at these information providers, a user can search for and obtain a variety of such information in databases or over networks and customize the information to his or her needs. In some of these areas, e.g. a hotel lobby, a “convenience printer” may be available to print out desired information. For example, the user would wish to print any information found and displayed on an information terminal. Or, the user may wish to access his or her personal email stored on a personal electronic device or stored over a global or other wide area computer network such as the Internet. Once viewed, the user may wish to print out one or more email messages. In another situation, a person may possess a portable electronic device that holds the information, but may not have a portable printer. For example, a user may have a laptop computer, a cell phone, personal organizer, personal digital assistant (PDA), notebook computer, etc., which stores information, such as emails, web pages, or other information that the user wishes to print. If a convenience printer or other printing device is accessible, the user can provide the information from his or her portable device to the printing device to have the information printed.

One problem with printing and copying information is that the costs of having this ability can run very high. Printers and copiers must be bought or rented, paper supplies maintained, toner and ink supplies stocked, and repairs paid for, which all contribute significant costs over time. For convenience printing, one problem is that public printing devices and terminals are not very widely available. One reason for this unavailability is that convenience printers are currently perceived as low-function, expensive, and inconvenient for the owner of the printing device and/or the establishment providing the device. When the presence of such a convenience printing device is required, e.g., at a hotel desk for guests, then the establishment views the devices as a cost. Some previous systems have implemented business schemes that ultimately charge the customer, e.g. using “micropayments,” small payments charged per use. Yet, customers may not want to use these types of public printing devices if the location owner charges a fee for every printing task. In addition, systems for reconciling micropayments may not be compatible or flexible between customers and establishments or print providers. A system and method is therefore needed to allow printing and other output devices to be more available, flexible and cost effective for the providers and users of such devices.

### SUMMARY OF THE INVENTION

The invention of the present application provides an apparatus and method for including advertisements in output tasks. In a first aspect of the present invention, a method for providing advertisements for a output device includes providing merchant data to the output device from a merchant, the merchant data including data describing at least one advertisement of the merchant to be available to be output by the output device, and providing data updates that are received by the output device, where the data updates modify the advertisements or the parameters by which the advertisements are chosen to be output by the output device. A different aspect provides a computer readable medium including program instructions for implementing similar steps.

In a second aspect of the invention, a method for receiving and transmitting advertisements to be output on an output device includes receiving merchant data from a merchant, the merchant data including data describing at least one advertisement of the merchant to be available to be output by the output device, receiving data updates, where the data updates modifying the advertisements or the parameters by which the advertisements are chosen to be output by the output device, and providing advertisement data derived from the merchant data and data updates to the output device, where the advertisements are to be output with other data requested by a customer operating the output device.

In a third aspect of the invention, a method for providing output data from an output device to a customer includes providing the output device, receiving merchant data at the output device, where the merchant data derived from parameters provided by at least one merchant pertaining to advertisements provided by the merchant which are available to be output by the output device, receiving a request for output data at the output device from the customer, and outputting the requested output data for the customer. At least one advertisement from at least one of the merchants is included in the output data based at least in part on the merchant data from the merchant, the merchant data including a bid from the merchant for priority in advertising.

In a fourth aspect of the invention, an apparatus for providing output data to a customer includes a receiving device capable of receiving merchant data, the merchant data derived from parameters provided by at least one merchant with respect to advertisements provided by the merchant and available to be output by the apparatus; an input device capable of receiving a request for output data at the output device from the customer; and an output device capable of outputting the requested output data for the customer. At least one advertisement from at least one of the merchants is included in the output data based at least in part on the merchant data and real-time updates from the merchant.

In a fifth aspect of the invention, a method for providing advertisements from an output device includes providing at least one advertisement from a merchant, where the advertisement is to be output by the computer-implemented output device, and allowing the merchant to directly adjust the content of the advertisement via a computer network in response to the merchant's immediate business needs.

The present invention provides methods and systems for including advertisements in output tasks, which allows revenue collected from merchants who advertise on the output devices to alleviate much of the cost of providing and maintaining printing and output services. The present invention allows advertising to be changeable dynamically and in real time by the merchant, adding a great amount of flexibility to the advertising and allowing the advertising to reflect current conditions of business and other dynamic business variables of the merchant.

### BRIEF DESCRIPTION OF THE DRAWINGS

FIG. 1 is a diagrammatic illustration of a system suitable for use with the present invention;

FIG. 2 is a diagrammatic illustration of one embodiment of an event sequence for providing advertisements to a customer of a print device of FIG. 1, in accordance with the present invention; and

FIG. 3 is a diagrammatic illustration of a block diagram of a system of the present invention showing the entities in the flow of information and control in the present invention according to the embodiment of FIG. 2.

### DETAILED DESCRIPTION

The present invention relates to providing advertisements, and more particularly to providing advertisements to customers needing printing or similar output services for information. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

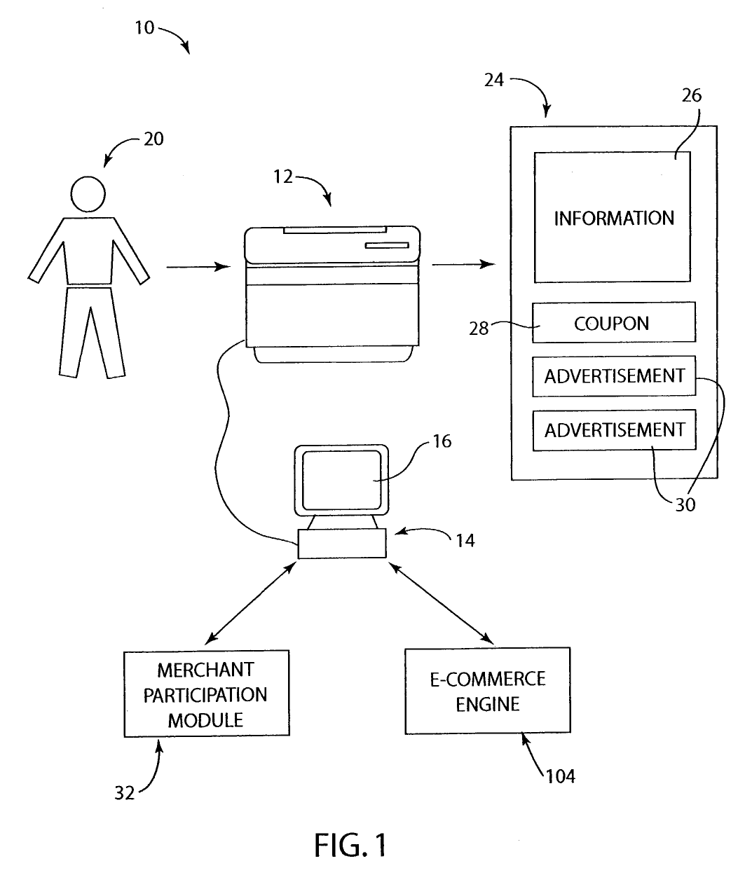

FIG. 1 is a diagrammatic view of a system 10 suitable for use with the present invention. System 10 includes an output device, here a printer device 12, and preferably includes a computer or electronic device 14 which optionally has a display 16. A customer 20 (i.e., user of the printer device) can use the printer device 12 and/or computer 14 to access information and/or obtain a printout (or other form of output) of desired information.

Several different embodiments are possible with the present invention. For example, in one implementation, print device 12 is a printer or copier provided in a business office environment, where employees use the print device 12 during their daily duties to make copies or printouts. In another embodiment, print device is a public device which is provided in a public area, such as a hotel lobby, store, airport, train station, etc., and any member of the public can access it to print out information possessed by the customer (e.g., stored on a portable electronic device), or to access the information and print out or otherwise output the information.

Computer or electronic device 14 can be in communication with printer device 12 in various embodiments to allow customer 20 to input information, to display information on a display device 16, to receive data from various sources, and/or to perform other processing of data. For example, in an office environment, a computer is often used to send the data to the print device 12 to be printed, or a computer is used to control the print device (as in a copier with built-in electronic functions). In an automated kiosk embodiment in a public establishment, computer 14 can allow the customer 20 to access and display various menus, maps, and any other information stored within the computer 14 or accessible to the computer 14 over a network or communication channel.

Preferably, the computer 14 includes a microprocessor, input and output electronics, data storage device (hard drive, memory, CD-ROM, etc.), communication and networking components, and other well-known components, and runs software suitable for the described tasks. The computer 14 and printer device 12 can be integrated into a single unit or housing, as in a copier or similar device, or the computer can be a separate unit, such as a personal computer, terminal, or workstation, in communication with the printer device 12. The computer 14 can in some embodiments allow the user to access and display the information that may be accessible over the Internet or other network, such as the user's email, web-based information, information stored on a different computer or server, etc. In other embodiments, the computer 14 may simply control the printer device 12 and/or receive data (such as requests) from the customer 20, e.g., through a wireless or other network, connection, input device, or media inserted into the computer or output device by the customer. When able to receive customer data, the computer 14/device 12 can in one embodiment include any of well-known input devices that are able to receive wireless transmissions, such as an optical detector, a wireless network receiver/transmitter, etc., from a portable device the user may be carrying. Or, other embodiments may allow the computer 14/device 12 to receive customer requests and data over a network, where the customer has gained access to the network via a terminal, or by plugging a device into the network (e.g. in a hotel room), etc. The computer 14 can store a list of merchants which are participating in the service provided by the printer device 12, as well as the data associated with each merchant. Or, this data can be stored on other computers (e.g., a server) and accessed through a network, such as the Internet.

The information obtained via computer 14, or information otherwise possessed by the customer 20, can be printed or otherwise output to the customer by the output device 12 according to the customer's request. In a common implementation of the present invention, printer device 12 is a printer that can be provided in a variety of different implementations, including a standard desktop printer (such as a laser printer, inkjet printer, etc.), copier, plotter, or a specialized printing device that includes the components needed for printing and outputting paper or other media with the information position thereon. In a typical printer embodiment, the printing device 12 is able to output one or more sheets of paper (or other physical media) having various graphics and/or text printed thereon, in black and white and/or color.

As used herein, the term “output device” in context of the present invention refers to a printer device 12 or any types of output devices which can output data in or to any form of media, and may or may not include actually dispensing that media to the customer. For example, a device that is capable of outputting or downloading digital data stored in the device 12 to a customer's device such as magnetic card, personal digital assistant (PDA), laptop computer, or other electronic storage device, is an “output device” that need not dispense a physical media since the user already possesses the required receiving storage media or device. In other instances, the output device can be a device that writes data to a piece of paper that is dispensed by the printer device (as described above), or an output device that can write desired data to one of several other types of portable physical media provided in the printing device 12 and dispensed to the customer, such as a magnetic card, CD-ROM, disk, memory chip, etc. Furthermore, the term “output device” as used herein generally includes the computer 14 or similar functionality.

A sample information printout 24 output from a printer output device 12 is shown. Printout 24 can include information 26, which is the information the customer requested to print or otherwise output. According to the present invention, the printout 24 may also include one or more advertisements, which can include coupons 28 and/or standard advertisements 30. The advertisements can be provided on the first sheet of several pages of output, or can be provided on each sheet, depending on the desired settings. Coupon 28 can be a special offer from one or more merchants or businesses to the customer, where the offer can be claimed by the customer by giving or presenting the printed coupon to the merchant. The coupon 28 can take a variety of forms. For example, the coupon can be a discount price on a product or service offered by the merchant, and which is redeemed by contacting the merchant (such as at a store, restaurant, booth, over a computer network, etc.) and giving the coupon when buying the product or service. The coupon can offer discount prices or fares, special services, prizes, tie-ins with other merchant's products or services, or any other offer having some financial, convenience, or other value to the customer. If the output device 12 is one that writes data to a form of portable media other than paper, then the coupon may be given to the merchant electronically (e.g., over the Internet) or via some other form of media exchange, such as wirelessly, e.g., via a local wireless network or communications link, a cell phone link, etc. For example, a user with a PDA or other portable computer storing an electronic coupon could go to the store or restaurant offering the coupon, where the coupon is automatically (or on command of the user) transmitted wirelessly to the store's computer system or electronic storage device.

Standard advertisements 30 are similar to the coupon 28 in that they advertise a product or service from one or more merchants. The standard advertisements, however, typically do not need to be offered or presented to a merchant to obtain a special offer or the product or service portrayed by the advertisement; they simply inform the customer of the merchant(s) and/or its products or services.

According to the present invention, the printout 24 obtained by the customer 20 is free to the customer 20, thus encouraging use of the printer device 12. The costs for printing or otherwise outputting the information to the customer are ultimately borne by the merchants who have elected to advertise their business via the coupons 28 and/or standard advertisements 30, as described in greater detail below.

A merchant participation module 32 is preferably accessed by the computer 14 to allow a variety of merchants to provide the information that determines the content, appearance, value, cost, and/or “behavior” of coupons 28 and advertisements 30. For example, module 32 can run on a commerce engine or server that are connected to the computer 14/device 12 via a network. The module 32 allows various merchants to send information to the computer 14/output device 12, such as advertisement data, rules for the use and outputting of that data, inventory or other data affecting what is printed in the advertisements, etc., as described below. The module 32 also allows merchants to access data from the output device 12, such as how many sheets or output data has been output, number of accesses by customers, number of advertisements from a merchant that have printed, and other statistical information.

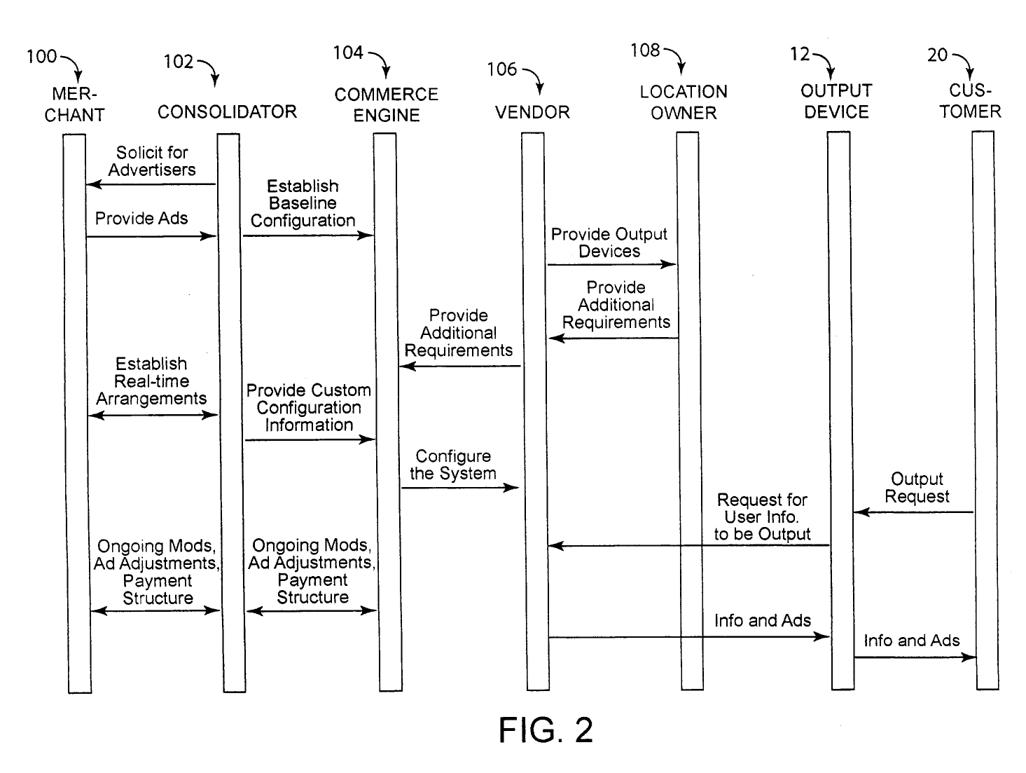

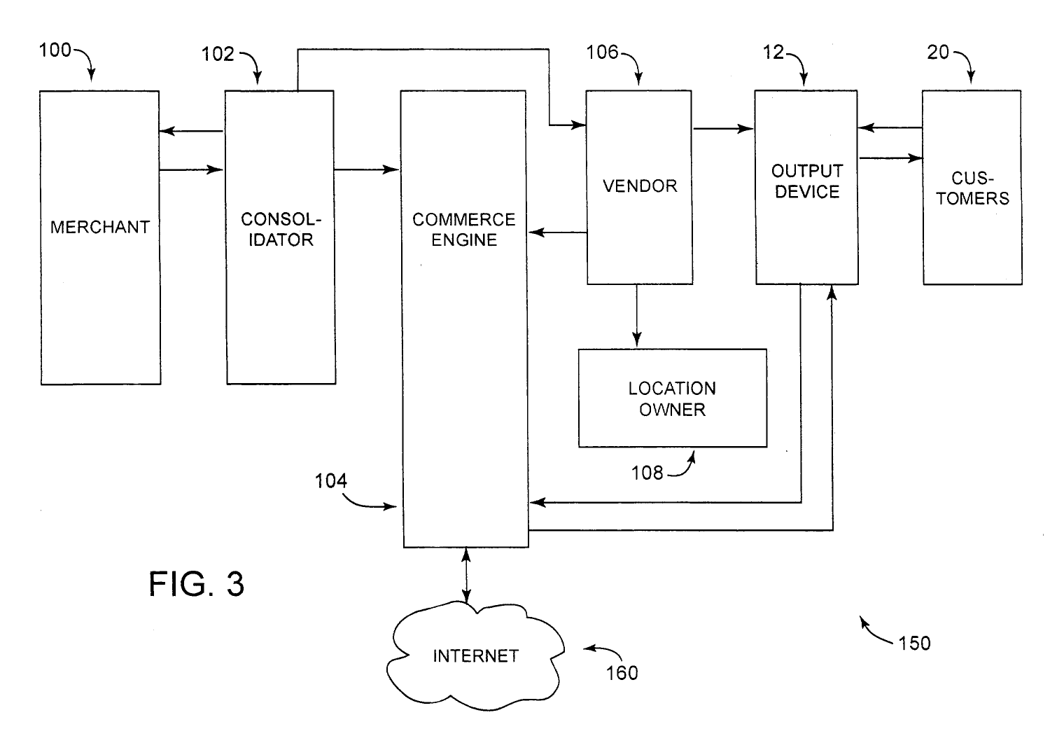

Commerce engine 104 can be software accessible by the computer 14 to allow merchants to bid on payments they will make to have their advertisements output by the output device 12, as well as to change parameters and preferences that govern such bidding. The commerce engine can be accessed by various entities in the methods of the present invention over the Internet, or the engine can be implemented in a local network. This is described in greater detail with respect to FIGS. 2 and 3. Such commerce engines are already known, e.g., software systems provided by IBM Corporation, BEA Systems, Inc., etc.

FIG. 2 is a diagrammatic illustration of one embodiment of an event sequence for providing advertisements to a customer of an output device of FIG. 1, in accordance with the present invention. Each entity in the business method is indicated by a vertical bar. Events in the diagram, indicated by horizontal arrows, occur in the sequence from top to bottom, with events positioned higher up and closer to the top of the diagram occurring before events positioned further down. Many of the events can be handled by program instructions implemented by computers and stored on computer readable media, such as hard disk, memory, CD-ROM, etc.

The entities in the business methods of the present invention can include one or more merchants 100, which are the businesses or other entities advertising as described above; a consolidator 102, which can organize several merchants together and act as a middleman between the merchants and the vendors 106 of the output device 12; a commerce engine provider 104, which provides the commerce engine software needed to determine the details of the advertising and to allow merchants to adjust parameters of their advertising schemes; a vendor 106, which can be used to sell and/or provide the output devices 12; a location owner, that owns the physical space needed to display and provide access to the output devices 12; and the customer 110, who accesses the output devices at the location to request output of data and receive advertisements.

As shown in FIG. 2, an early event in the process is that a consolidator 102 solicits for advertisers by approaching merchants 100. The consolidator can be a company, web service, or other organization that determines which merchants in a geographic area, or in particular industries, or which provide particular types of goods and services, may be interested in providing advertisements that get printed on output device 12. Once a merchant 100 has agreed to participate, the merchant provides data describing advertisements to the consolidator 102 as shown in FIG. 2. The merchant can send the data to the consolidator in any of a variety of possible ways, including over a computer network such as the Internet. The consolidator 102 then establishes a baseline configuration with a commerce engine provider 104. This baseline configuration provides the commerce engine with all the basic data needed to establish the merchants' parameters in the commerce software system, including the starting amount that the merchant will pay for advertising, and terms and conditions for paying more or less to increase or lower priority of a merchant with respect to other merchants, as described in greater detail below. This information can be provided to the commerce engine via standard methods initially (contracts, etc., or by computer networks). Thereafter, updates and changes can be provided by electronic methods such as computer networks.

Meanwhile, the vendor 106 can provide one or more output devices 12 to a location owner 108. The vendor 106 can be any of a variety of different entities, and in some cases the vendor and the location owner can be the same entity. For example, one embodiment has a vendor 106 that is a separate company that owns the output devices 12 and rents space in the location owned by the location owner to place output devices 12, where the rent is paid to the location owner 108. In a different embodiment, the vendor 106 is essentially the same as the location owner 108, e.g., when the location owner buys an output device 12 and places it at the location, and receives payment from merchants for advertising.

As shown in FIG. 2, the location owner 108 may ask additional requirements of the vendor 106. For example, the location owner may only want certain types or categories of merchants to be able to advertise at the location. Thus, an airport location may only want to allow merchants such as local restaurants and taxi cab services to be able to advertise, while a shopping mall may only want the stores within the mall to be able to advertise. Other restrictions might include the maximum or minimum amount of discounts that can be offered in coupons, the maximum or minimum number of advertisements per printout, etc. For some location owners, a very diverse and complex set of requirements and restrictions can be used and/or changed by the location owner; for example, a store location might require that no coupons promoting liquor be printed on Sundays. The vendor 106 then provides these additional requirements, and any others added by the vendor, to be incorporated in the commerce engine 104 as shown in FIG. 2. Commerce engine 104 then knows which merchants are eligible for which location and which output devices, and can let eligible merchants place bids and compete for advertising.

The merchant 100 and consolidator 102 then can establish any desired real-time arrangements, which can include, for example, an indication of which parameters for advertisements the merchant can adjust at a later time, in real time over the computer network. The merchant can adjust the appearance, value, expiration date, or other aspects of its advertisements, according to nearly instantaneous business needs, microgeographical areas, and other factors, as detailed below. The consolidator 102 can then provide custom configuration information to the commerce engine 104 for each participating merchant 100, where the custom configuration information provides details for the real time arrangements and how each merchant will be able to bid for prices using the commerce software, e.g., maximum bids, how particular events will influence bids, valid bid increments, minimum starting bid, time-based bid conditions, etc. Using the custom configuration information, the commerce engine 104 then can provide information to the vendor 106 to configure the output device systems based on the merchant information (or, in some embodiments, the commerce engine can configure output devices 12 directly via a network). Thus, the advertising settings can be set for each output device 12 based on information that the commerce engine derives from the base configuration and custom configuration information for each merchant. The output devices 12 are then ready for use with customers.

In some embodiments, when a customer uses an output device 12, a request may be made to the output device 12 from the customer 20, as shown in FIG. 2 to obtain information, such as the customer's email, or descriptive information on a subject of interest to the user, e.g., desired information about local businesses, maps, reservations for a product or service, etc. The output device 12 can request the user information from the vendor 16 as shown in FIG. 2, or can request this information from another source (the World Wide Web, a database server, etc.). The vendor 106 (or other information source) responds by providing to the output device 12 the requested information as well as any advertisements to be included in the output with the requested information. Alternatively, the output device 12 can consult locally stored data as which advertisements to output, where the locally-stored data is updated at different times by the commerce engine or vendor. The output device 12 provides the information and advertisements to the customer 20 in the form of a printout (or other output), as described above. The output advertisements are based on the appropriate parameters including merchant bids, eligibility of merchants for that output device 12, the baseline configurations of the merchant, etc.

As shown in FIG. 2, previous, during, and after this request by the customer for the information, the merchant 100 can provide ongoing modifications, advertisement adjustments, and payment structure information to the consolidator 102, who can then provide this information to the commerce engine 104. Furthermore, the commerce engine 104 can send the current pertinent information for a merchant to the consolidator 102, who can send the information to the merchant, e.g., when the merchant requests to see the current settings and information pertaining to that merchant for one or more output devices 12, locations, etc. as stored in the commerce engine.

This method and system can provide several advantages to the participants in the method. For example, for the merchant 100, additional customers for the merchant's business are gained when the customers of the output device 12 see the merchant's advertisements. The consolidator 102 can receive a portion of the revenue from the merchants for providing the advertisements (a portion can also go to the vendor 106). The commerce engine provider 104 can be paid for the commerce engine's service to the interested parties, e.g., by the consolidator 102 and/or vendor 106. The vendor 106 can receive a portion of the advertising revenue from the merchants that are advertising on the vendor's output devices 12 (subtracting the cost of the output devices 12 and the rent, if any, of the locations for actual profit). The location owner 108 can receive rent from vendors 106 and provide a service to customers 110. Customers 110 have access to an output device 12 for their informational needs, and do not have to pay any monetary costs for obtaining printouts or other output.

FIG. 3 is a block diagram of a system 150 of the present invention showing the entities in the business flow and the flow of information and control according to an embodiment similar to that of FIG. 2. Merchant 100 decides to advertise (in some cases, after being approached by consolidator 102 or vendor 106) and sends static advertisement information that defines the merchant, descriptive information for the advertisements (graphics, sounds, etc.), payment arrangements, etc., to the consolidator 102. The merchant 100 also provides real-time adjustment rules as to how the merchant wants to adjust the advertising parameters in the system, and makes real-time adjustments during system operation to adjust to operational and other needs. Thus, the merchant sends static advertisement information, real-time adjustment information, real-time adjustment rules, and payments for the ability to advertise to the consolidator 102.

Flow from the consolidator 102 to the commerce engine 104 includes the baseline configuration of each merchant and vendor to the providers of the commerce engine 104. As explained above, the baseline configuration provides the commerce engine with all the basic data needed to establish the merchants' parameters in the commerce software system, and can include the starting bidding value for advertisements provided by each merchant.

The consolidator 102 also provides custom and real-time configuration information to the commerce engine 104. This information is based on the information and preferences from the merchant and is used to configure the settings of the merchant in the commerce engine. The consolidator also has the real-time adjustment rules and real-time adjustment information that the merchant is sending to the consolidator, which the merchant can be adjusting in real time based on “dynamic business variables” of the merchant, which can, for example, include the current conditions of the merchant's business, such as amount of inventory in particular items, pace of business, profitability, etc. The dynamic business variables can also be business opportunities or a change in status or event that the merchant wishes to take advantage of in real-time; for example, a business convention or sports game in town might offer more business, and the merchant may wish to adjust his advertisements appropriately. This adjustment information can include payment structure adjustments, advertisement (coupon) price or expiration date adjustment, other ad content adjustments, adjustments of bid price for advertising, etc. The consolidator uses these real-time adjustments and rules to provide information to the commerce engine 104 for ongoing adjustments to the advertisements, and any adjustments to the payment structure. In some embodiments, adjustment rules can automate the adjustment process, where the rules govern how these parameters can change over time, so that the merchant need not actively provide adjustments. The merchant is also able to adjust parameters and make adjustments manually.

The consolidator 102 sends a variety of information back to the merchant 100, including sales information for the advertisements, indicating how many advertisements from that merchant have been output, current bid payment price, and any other desired statistical information. The consolidator 102 also sends billing information to the merchant 100, indicating the amounts due based on advertisements that have been output. There is also flow from the consolidator 102 to the vendor 106, in the form of payment for the use of the vendor's output devices 12 (for which the vendor bills the consolidator). Such payment is used for embodiments in which the vendor owns the print device business; in other embodiments, the consolidator can own the print device business, and no such payment would be needed, or the consolidator can pay other entities, such as the location owner if that owner also acts as vendor 106.

In basic function, the commerce engine 104 establishes a baseline configuration for each merchant “matrix cell,” where, for example, the matrix can include cells for each merchant that corresponds to a particular vendor (or consolidator, location owner, etc.) to allow the merchants and vendors (and/or consolidators, location owners, etc.) participating in the system to see the participating merchants and their current parameters and bids. For example, in one implementation, the matrix can show various output devices 12 or locations along one axis, and the participating merchants along the other. The baseline configuration is based on the information provided by the consolidator 102 as described above. The commerce engine 104 also can establish adjustment rules and algorithms for each cell in the matrix, based on the customer and real-time configuration information provided by the consolidator which was based on participating information. The commerce engine preferably includes “business-to-business” software, e.g. that type of software provided IBM Corp., such as Websphere®.

By using the commerce engine to designate particular output devices and locations, as well as the types of information that the advertisements can be output with, the merchant can specify where and how he wants his products and services advertised. This allows advertisements to be narrowly directed to only the customers that are likely to be interested in them. For example, an advertisement from a merchant can be included in output if the requested information for the customer is related to the business of the merchant. For example, a taxi service merchant can specify that advertisements are to be output only at public output devices at airports and railway stations, or are only to be output when a customer requests map information or location information from an output device. In a different office business setting, only merchants that offer goods and services of value to the business might be interested in advertising at output devices in use by that business.

An important aspect of the invention is the ability of merchants to compete in real-time for the ability to advertise on output devices 12. In one embodiment, merchants are able to “bid” how much they are willing to pay the vendor (and/or consolidator, etc.) for the right to advertise. The merchant(s) who will be advertised on the next printout of an output device 12 is that merchant having the highest bid, i.e. is willing to pay the most for the right to advertise. The commerce engine 104 keeps track of all the current bids of the merchants and sends data to an active output device, instructing the output device to output advertisements of the merchant(s) having the highest bid. Bidding can be handled using a variety of different methods, including open auctions, closed or secret bidding, or any method well-known to those of skill in the art.

Adjustment rules and information allow a merchant to change many different aspects of the advertising dynamically and in real time, according to changing circumstances, dynamic business variables, etc., where “dynamically” refers to the ability to change the advertising based on changed circumstances and conditions, and “real time” refers to the ability to change the advertising substantially immediately after the need or desire to do so is recognized or decided upon. For example, the content of the advertisements themselves can vary; different products can be advertised based on current popular items, coupon values and/or expiration dates can be changed based on how much business a merchant is currently getting or the particular location or environment in which the coupon is printed; the times of the day that the coupons are allowed to be output can be specified in rules; etc. For instance, a merchant can specify the amount of discount or amount of time before a printed coupon will expire, and that discount or time duration can be adjusted dynamically and in real-time based on changing circumstances and dynamic business variables, such as the amount of additional customers the merchant currently wishes to attract. Thus, a coupon might be able to provide very precise discounts based on current inventories or the like. For example, a liquor store kiosk might print out coupons offering 59 cents off certain purchases of a liquor that is slightly overstocked. The merchant's changes can be conveyed via computer networks to the commerce engine and output devices based on automated rules that recognize changed circumstances, or based on the merchant's manual commands.

Adjustment rules can allow the merchant to pay different bid amounts in order to get priority to advertise on printouts or other output over other merchants, and these bids can be changed based on different circumstances and/or business conditions. For example, if a merchant has a surplus of a certain item, the merchant may be willing to bid and pay a higher price in order to print advertisements (such as coupons) in the hope of selling more of the surplus item. If the surplus is known to the system, the commerce engine can use the adjustment rules to automatically adjust that merchant's bid on the commerce engine to create a greater chance that one of his advertisements will be printed by the output device instead of other merchants' advertisements. This allows the cost of advertising for the merchants to vary dynamically, based on their need to generate business. Alternatively, the merchant can manually change a bid value.

Merchants can also designate and/or bid on the number of advertisements to print. For example, the merchant discovering a surplus amount of items can indicate to the commerce engine that he wants a greater number of coupons printed than the maximum number previously indicated. The maximum number of advertisements can be specified over a period of time, for a particular set of output devices or locations or geographical area, and/or with other criteria. In some embodiments, several different merchants can bid as to how many advertisements each of them can output. Other embodiments may not enforce any maximum number of advertisements.

The commerce engine 104 can send out advertisement data to the output devices 12 to provide how the advertisements appear, govern which advertisements are printed, determine the value or expiration date of coupons, etc. Alternatively, some of all of this advertisement data can be provided to the output devices from other sources. This information can be sent over a wide area computer network such as the Internet 160, where each output device 12 (or a server that is connected to the output devices) is accessible and can access that same network. This allows the output devices 12 to be updated in real-time and shortly after the merchants and others in the business method desire the changes. In some embodiments, the commerce engine 104 also can receive information over the Internet (or other network) from the output devices 12, such as customer requests, statistical information on customers' use of the output device over time, etc. In addition, the communication between the commerce engine 104 and all the other entities in the business method that it communicates with can be provided over a network such as the Internet. In other embodiments, other distribution methods can be used to provide the output devices 12 with the needed data and updates.

The commerce engine also receives payment from, in the described embodiment, the vendor 106 for the use of the commerce engine for the business implementation. This payment can be received from other entities (e.g., the consolidator, location owner, etc.) in other embodiments. The commerce engine can also handle the billing and bill tracking of other entities in the system in some embodiments.

In preferred embodiments, the commerce engine 104 need not be directly involved in the response to a customer's request for information content, or the output of that content, from an output device. Thus, other information retrieving services or programs can satisfy the request for email or other information, while the commerce engine 104 used in the present invention need only be concerned with the output of advertisements and related data. This allows the customer to retrieve information more efficiently and be unconcerned with transactions involving the payment for the service of the output device. Thus, if a customer requests to see his or her personal email stored on a server on the Internet, that email can be accessed through the Internet 160 without having to access functions of the commerce engine 104. Alternate embodiments may provide a commerce engine 104 that is responsible for or otherwise linked to the process of retrieving information content for the output device 12.

The advertisements other data used by the system can be provided in a variety of implementations of software and protocols. For example, Extensible Markup Language (XML) can be used for the advertisement data describing how the advertisements appear. In one application, XML can allow for dynamic price values on printed coupons. The data content can be transmitted using any of a variety of protocols. For example, Simple Object Access Protocol (SOAP) can be used to transmit the XML, which is often used in business-to-business data exchanges. Various well-known security protocols and methods can be used when transmitting data in the present invention, such as authentication, non-repudiation, encryption, or photocopy protection.

The vendor 104 can supply the output devices 12 for use in the present invention to the location owner 108 in some embodiments. The vendor can also provide rent payment to the location owner 108 for the use of the space needed to display and house the output device 12. In other embodiments, the location owner may also act as vendor, and/or other entities can include the vendor. The vendor can pay the commerce engine provider 104 in some embodiments for the use of the commerce engine, as described above. Furthermore, the vendor may also be responsible in some embodiments for providing maintenance for the output device 12, e.g. send out or pay for servicing agents which repair and maintain the output device 12 at the location.

The location owner 108 can rent out space at the location to the vendor to provide space to place the output devices 12. In various embodiments, the location owner can also act as a vendor, a merchant (e.g., to advertise its own products or services), commerce engine provider, and/or as a consolidator.

The customer 20 accesses the output device 12 to output desired information (and retrieve the information as well in some embodiments, if it is not already possessed by the customer). As described above, the desired information can describe anything the customer wishes and which may be stored in informational databases or on the Internet. Furthermore, the customer can input follow-up information to the output device 12 for selections, elaboration or confirmation. For example, the customer can request information on local theatres and purchase a ticket or make a reservation as a follow-up. In some embodiments, such as in a business office or store, the customer 20 may also be the location owner 108 who has rented or bought the output device 12 for its use by the location owner at the location.

In some embodiments, it is desirable to limit the advertisements to pre-stored, verified and static templates that are stored or lached in the output device 12 or commerce engine 104. This may prevent spontaneous insertion of unwanted advertisements (e.g., such as graffiti) into the system. In the case of storing the data on the output device, this can also allow improved performance and quality since the logo or artwork can be high-resolution without having to download large amounts of data, where the smaller amount of content data (e.g., name, coupon discount price, expiration date) can be downloadable and changeable. For example, merchants can download new templates for different artwork and appearance at predetermined times.

The appearance of the printout or other output can be set via rules on the output device 12, e.g. where the customer information is positioned, where the advertisements are placed, the size of the advertisements, etc. Alternatively, a merchant can send a desired format to the vendor 106, commerce engine 104 or output device 12.

In preferred embodiments of the present invention, the customer need not pay anything to receive public output services, since the advertisements pay for the cost of operation of the output device. The customer would not have to deal with “micropayments” or any other billing scheme. In some embodiments, it may be desirable to limit the amount of data that is output, since advertisements might be able to support only so much of the cost of operating the output device. For example, a customer might be limited to printing four pages of information with advertisements. If more pages than the maximum are to be printed, the customer can be charged a fee. In some other embodiments, the advertisements may just reduce the cost of operating and using the output device 12 to the customer. For example, if the output device 12 is an office copier or printer rented by a location owner/customer, the vendor 106 can offer the rental and maintenance of the output device 12 to the customer at a much-reduced rental rate if the advertisements of the present invention are provided.

In some implementations, the customer may not need to access an information input terminal on the output device, or the like, if the customer has an appropriate electronic device capable of sending signals to and receiving signals from the output device 12. For example, a wireless device possessed by the customer, such as a cell phone, can run a communication protocol compatible with the output device 12 so that the output device can send information, such as commands and menu items, to the cell phone to be displayed, and the cell phone can send data, such as a command to print and the data to be printed, to the output device. The wireless communication can be implemented in any of a variety of available protocols and standards, e.g. Bluetooth, or Wireless Application Protocol (WAP). To allow the output device 12 to detect the presence of the customer's electronic device, a standard discovery protocol can be used, such as Rendezvous, Domain Name Services Service Discovery (DNSSD), Salutation, Jini, Universal Plug and Play (uPnP), etc. Messages can also be sent to and from the output device 12 using notification and business messaging, e.g., instant messaging.

### EXAMPLES OF THE INVENTION

The present invention can be used in a variety of settings and in a variety of ways. Some examples of different embodiments or applications are described below.

### First Example

A business office wishes to rent copiers for its business. A particular vendor company rents copiers and offers the copiers at a very reduced rate if a set of merchants are allowed to provide advertisements on the copier. The business office decides to rent the reduced-rate copiers with the advertising. The vendor approaches a consolidator company to ask for a list of merchants who wish to advertise at this business' location. The consolidator approaches a variety of merchants and achieves a list of merchants who wish to participate, such as office supplies and furniture dealers, business software and computer hardware merchants, and merchants related to the core business of the business office. The merchants provide their bids and other advertising data to the consolidator for use with the system.

When in use at the business, the rented copiers are used like normal copiers. However, at the beginning of every copy task, a sheet(s) of one or more advertisements from one or more of the participating merchants is first output from the copier, e.g., the first page of the copied stack (printout) of paper (where the rest of the copied pages are the “requested information” requested to be copied by the customer). Depending on the arrangements with the vendor, etc., the advertisements can also be output on sheet(s) at the end of a copy task, in the middle between multiple-copy tasks, etc.

### Second Example

A person lands at an airport in an airplane. Upon landing, the person activates his cell phone, and a new message on the cell phone urges him to review a 3-page email before his next appointment. To more conveniently read the email, the person decides to print it out. He (now the “customer”) goes to an output device 12 which is located in the airport, e.g., near a store, information booth, etc. As he approaches the output device, his cell phone receives a wireless transmission from the output device, beeps and displays an icon of the logo for the airport he is at and which provides the space for the output device (the location owner). The person presses the icon and selects from a list of services that are displayed on the cell phone screen: local information; headlines and weather; financial headlines, and “print from local printer.” These options are provided by the output device 12 and can access information either stored locally or retrieved out over the World Wide Web or elsewhere on the Internet. The person selects the print option from his cell phone and selects the email message, so that the output device 12 prints out the email. He is not charged any fee for this printing service.

A few minutes ago, a driver for a local taxi service drove his taxi to the main terminal of the same airport. The taxi service is a merchant participating in the advertising method for the print devices in the airport. The taxi that just drove up is detected by a scanner at the airport. This arrival raises the number of taxis from that taxi service waiting at the airport to three, and this automatically raises the bid of that taxi service, i.e. the price that that merchant is willing to pay to generate coupons or advertisements from the output device 12. The automatic adjustment of the bid can be according to the adjustment rules agreed to by the merchant and consolidator. For example, when three taxis are detected to be idly waiting at the airport instead of two, the bid of the taxi service to print their advertisements might increase from 10 cents to 15 cents per printed advertisement. This increases the probability that the next customer of the airport print devices would receive an advertisement for the taxi service. This also allows the taxis service to automatically and dynamically adjust advertising based on current business needs.

In the current example, the person who printed the email gets his printout of his email, which has a coupon attached at the bottom of the printout which is easy to notice. The coupon says that the taxi service mentioned above currently has three taxis ready and waiting for any passengers right outside specified doors of the airport. The coupon also states that if the receiver of the coupon chooses to ride with one of these taxis within 20 minutes of when the coupon was printed (the time and expiration date is also printed), that person will receive a 20% discount on the taxi fare. This may greatly increase the chance that the customer will choose one of the taxi service's three taxis, thereby increasing the taxi service's revenue.

### Third Example

A hotel guest arrives at a hotel lobby. The front desk is busy and no help from hotel employees seems available, but an automated kiosk is situated in the hotel lobby. The guest accesses information on the kiosk using an input device such as a touchscreen (or mouse, keyboard, trackball, pointing device, etc.) to display information on a screen about local places to eat. Through various lists or menus, the guest eventually selects “local light fare” and is presented with a list of seven restaurants and bars along with descriptions, sample menus, and prices. The guest is undecided about which place to eat at, but notices that one restaurant is offering a coupon for “first drink free,” valid for that night only. The guest selects that restaurant, requests directions for how to get there, and gets a printout with the information and the coupon. No fee is charged the guest for the printout.

In a similar situation, the guest may be presented a choice as to whether to make a reservation at the selected restaurant. If the guest selects the option to make the reservation, the guest also can request an estimate of travel time when traveling by foot. Or if the guest decides to call a taxi, the guest can reserve and call a taxi using the same kiosk by making the appropriate selections. The guest can input the desired time when the taxi should arrive at the hotel and then would get the printout showing the desired information and the confirmed reservations of both the taxi and at the restaurant.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for providing advertisements for an output device, the method comprising:
(a) providing merchant data to the output device from a merchant, the merchant data including data describing at least one advertisement of the merchant to be available to be output by the output device; and
(b) providing data updates that are received by the output device, the data updates modifying the advertisements or the parameters by which the advertisements are chosen to be output by the output device.

2. The method of claim 1, wherein the output device outputs requested data that is requested by a customer, wherein at least one advertisement from the merchant is output with the requested output data.

3. The method of claim 2, wherein other merchant data from other merchants has been provided to the output device, and wherein a selection is made of at least one merchant's advertisement to be output with the requested output data.

4. The method of claim 1, wherein the merchant data and data updates are provided to a commerce engine which provides data derived from the merchant data and data updates to the output device.

5. The method of claim 4, wherein the merchant data and data updates are received by the commerce engine over a computer network.

6. The method of claim 1, wherein the merchant data includes a baseline configuration that establishes the desired frequency of outputting the advertisements and the price that the merchant will pay for the output of the advertisements.

7. The method of claim 1, wherein the data updates include parameters to change the payments that the merchant is willing to make for output advertisements.

8. The method of claim 1, wherein the merchant data and data updates are provided to a consolidator that receives other merchant data and other data updates from a plurality of other merchants, wherein the consolidator provides data derived from merchant data and data updates to the output device.

9. The method of claim 1 wherein the merchant data includes a bid for the price that the merchant is willing to pay to output advertisements.

10. The method of claim 1 wherein the merchant data includes a maximum number of advertisements that the merchant is willing to output by one or more output devices.

11. The method of claim 9 wherein the data updates include changes from the merchant to the bid from that merchant.

12. The method of claim 11 wherein the changes to the bid are based on dynamic business variables of the merchant.

13. The method of claim 1 wherein the advertisements from the merchant include at least one coupon, and wherein the data updates include changes to the redeemable value of the at least one coupon or changes to the expiration date of the at least one coupon.

14. A method for receiving and transmitting advertisements to be output on an output device, the method comprising:
(a) receiving merchant data from a merchant, the merchant data including data describing at least one advertisement of the merchant to be available to be output by the output device;
(b) receiving data updates, the data updates modifying the advertisements or the parameters by which the advertisements are chosen to be output by the output device; and
(c) providing advertisement data derived from the merchant data and data updates to the output device, wherein the advertisements are to be output with other data requested by a customer operating the output device.

15. The method of claim 14, wherein other merchant data and other data updates from other merchants is received, and wherein a selection is made of at least one merchant's advertisement to be output with the requested output data based on the received merchant data and data updates.

16. The method of claim 14, wherein the merchant data and data updates are received by a commerce engine which provides the advertisement data to the output device.

17. The method of claim 16, wherein the merchant data and data updates are received by the commerce engine over a computer network, and the advertisement data is provided over the computer network.

18. The method of claim 14, wherein the merchant data includes a baseline configuration that establishes the desired frequency of outputting the advertisements and the price that the merchant will pay for the output of the advertisements.

19. The method of claim 14, wherein the data updates include parameters to change the payments that the merchant is willing to make for output advertisements.

20. The method of claim 14, wherein the merchant data and data updates are received from a consolidator that receives other merchant data and other data updates from a plurality of other merchants.

21. The method of claim 14 wherein the merchant data includes a bid for the price that the merchant is willing to pay to output advertisements.

22. The method of claim 15 wherein the merchant data includes a bid for the price that the merchant is willing to pay to output advertisements, and further comprising selecting an advertisement to be output based on the value of the bids from the merchants.

23. The method of claim 22 wherein the data updates include changes from the merchant to the bid from that merchant.

24. The method of claim 23 wherein the changes to the bid are based on dynamic business variables in the merchant's business.

25. The method of claim 14 wherein the merchant data includes a maximum number of advertisements that the merchant is willing to output by one or more output devices.

26. The method of claim 14 wherein the advertisements from the merchant include at least one coupon, and wherein the data updates include changes to the redeemable value of the at least one coupon or changes to the expiration date of the at least one coupon.

27. The method of claim 15 wherein an advertisement from a particular merchant is considered to be provided to an output device if the requested information for the customer is related to the business of the particular merchant.

28. A method for providing output data from an output device to a customer, the method comprising:
(a) providing the output device;
(b) receiving merchant data at the output device, the merchant data derived from parameters provided by at least one merchant pertaining to advertisements provided by the merchant which are available to be output by the output device;
(c) receiving a request for output data at the output device from the customer; and
(d) outputting the requested output data for the customer, wherein at least one advertisement from at least one of the merchants is included in the output data based at least in part on the merchant data from the merchant, the merchant data including a merchant bid for priority to advertise on the output device.

29. The method of claim 28 wherein the wherein at least one advertisement from at least one of the merchants is included in the output data based at least in part on real-time updates from the merchant.

30. The method of claim 28 wherein the output device includes a print device, and wherein the output data output by the print device includes a printout on paper.

31. The method of claim 28wherein the output data includes data sent to and stored by a electronic device possessed by or accessible to the customer.

32. The method of claim 28 wherein the output data is provided substantially cost-free to the customer.

33. The method of claim 28 wherein multiple merchants each provide at least one advertisement that is available to be included with the output data, and wherein at least one of those advertisements is selected to be included with the output data.

34. The method of claim 33 wherein the selection of advertisements to be included with the output data is based at least in part on the merchant data provided by the merchants, wherein the merchant data includes a bid by each merchant to pay for the ability to advertise via the output device.

35. The method of claim 34 wherein the advertisement having the highest bid has the highest priority to be included in the output data.

36. The method of claim 34 wherein the bids from the merchants are organized in a commerce engine accessible by the merchants and accessing the output device over a computer network.

37. The method of claim 33 wherein the number of advertisements from each merchant to be provided with output data is based at least in part on the value of the bid by each merchant to pay for the ability to advertise via the output device.

38. The method of claim 33 wherein the maximum number of advertisements to be output over a predetermined period of time is determined based at least in part on the merchant data provided by the merchant.

39. The method of claim 28 wherein at least one advertisement included in the output data includes a coupon offering a discount price on a product or service offered by the merchant providing the coupon.

40. The method of claim 39 wherein the merchant data includes data determining how the coupon appears when the output data is viewed by the customer.

41. The method of claim 39 further comprising receiving adjustment data at the output device from the merchant to change the discount price offered on the coupon based on changed circumstances.

42. The method of claim 39 further comprising receiving adjustment data at the electronic device from the merchant to change an expiration date of the coupon based on changed circumstances.

43. The method of claim 28 wherein the request for output data from the customer includes a selection or command on an electronic device in the possession of the customer, where the selection or command is sent to the output device wirelessly.

44. The method of claim 28 wherein the request for output data from the customer includes inputting the request at an input device that is connected to the output device.

45. The method of claim 28 wherein the advertisement is included in output data if the request of the customer is related to the business of the merchant.

46. An apparatus for providing output data to a customer, the apparatus comprising: a receiving device capable of receiving merchant data, the merchant data derived from parameters provided by at least one merchant with respect to advertisements provided by the merchant and available to be output by the apparatus;
an input device capable of receiving a request for output data at the output device from the customer; and
an output device capable of outputting the requested output data for the customer, wherein at least one advertisement from at least one of the merchants is included in the output data based at least in part on the merchant data and real-time updates from the merchant.

47. The apparatus of claim 46 wherein the output device includes a print device, and wherein the output data output by the print device includes a printout on paper.

48. The apparatus of claim 46 wherein the output data includes digital data sent to and stored by a device possessed or accessible by the customer.

49. The apparatus of claim 46 wherein the output data is provided at substantially cost-free to the customer.

50. The apparatus of claim 46 wherein multiple merchants each provide advertisements that are available to be include with the output data, and wherein at least one of those advertisements is selected to be included with the output data.

51. The apparatus of claim 50 wherein the selection of advertisements to be included with the output data is based at least in part on the merchant data provided by the merchants, wherein the merchant data include a bid by each merchant to pay for the right of advertising via the electronic device.

52. The apparatus of claim 46 wherein the at least one advertisement included in the output data includes a coupon offering a discount price on a product or service offered by the merchant providing the coupon.

53. The apparatus of claim 52 wherein the merchant data determines how the coupon appears when the output data is viewed by the customer.

54. The apparatus of claim 46 wherein the receiving device includes a network connection that can receive data over a computer network.

55. The apparatus of claim 46 wherein the input device includes a device capable of receiving a selection or command made by the customer on a device in the possession of the customer, where the selection or command is received wirelessly by the input device.

56. The apparatus of claim 46 wherein the input device includes keyboard, touchscreen, mouse, or trackball.

57. A method for providing advertisements from an output device, the method comprising:
(a) providing at least one advertisement from a merchant, wherein the advertisement is to be output by the output device; and
(b) allowing the merchant to directly and substantially immediately adjust the content of the advertisement via a computer network in response to the merchant's immediate business needs.

58. The method of claim 57 wherein the advertisement is output with information requested by a customer operating the output device.

59. The method claim 58 wherein the output device includes a print device that provides the requested information and advertisement to the customer on a physical printout.

60. The method of claim 57 wherein the advertisement includes a coupon offering a discount value in accordance with the merchant's current pace of business.

61. A computer readable medium including program instructions to be implemented by a computer, the program instructions for providing advertisements for an output device, and implementing steps comprising:
(a) providing merchant data to the output device from a merchant, the merchant data including data describing at least one advertisement of the merchant to be available to be output by the output device; and
(b) providing data updates that are received by the output device, the data updates modifying the advertisements or the parameters by which the advertisements are chosen to be output by the output device.
